(19) United States
(12) Patent Application Publication
(10) Pub. No.: US 2026/0005340 A1
(43) Pub. Date: Jan. 1, 2026

(54) BATTERY CELL DESIGNS THAT FACILITATE INCREASED HEAT TRANSFER AND THERMAL PERFORMANCE

(71) Applicant: FORD GLOBAL TECHNOLOGIES, LLC, Dearborn, MI (US)

(72) Inventor: Adam Bangerter, Dearborn, MI (US)

(21) Appl. No.: 18/760,408

(22) Filed: Jul. 1, 2024

(51) Int. Cl. H01M 50/103; H01M 10/04; H01M 10/613; H01M 10/643; H01M 10/647; H01M 10/6551; H01M 10/6561; H01M 50/109; H01M 50/119; H01M 50/153; H01M 50/159; H01M 50/209; H01M 50/216; H01M 50/291

(52) U.S. Cl. CPC H01M 50/103; H01M 10/04; H01M 10/0431; H01M 10/613; H01M 10/643; H01M 10/647; H01M 10/6551; H01M 10/6561; H01M 50/109; H01M 50/119; H01M 50/153; H01M 50/159; H01M 50/209; H01M 50/216; H01M 50/291; H01M 2220/20

(57) ABSTRACT

Battery cells are described for use within traction battery packs. The exemplary battery cells include designs that facilitate increased heat transfer and thermal performance. For example, an exemplary prismatic battery cell may include an electrode assembly having a plurality of electrode stack layers, and each electrode stack layer of the plurality of electrode stack layers includes a major side surface that is positioned normal to a major face of a prismatic outer housing of the cell. An exemplary cylindrical battery cell may include a first plurality of standoffs protruding outward from a base of an cylindrical outer housing of the cell, and a second plurality of standoffs protruding outward from a cover of the cell. The standoffs cooperate to establish cooling channels when the cylindrical battery cell is stacked together with additional cylindrical battery cells.

### TECHNICAL FIELD

This disclosure relates generally to battery cells, and more particularly to battery cell designs that facilitate increased heat transfer and thermal performance.

### BACKGROUND

A high voltage traction battery pack typically powers the electric machines and other electrical loads of an electrified vehicle. The traction battery pack includes a plurality of battery cells. Some traction battery packs utilize pouch battery cells.

### SUMMARY

A prismatic battery cell according to an exemplary aspect of the present disclosure includes, among other things, a prismatic outer housing including a first major face and a second major face, and an electrode assembly arranged inside the prismatic outer housing. The electrode assembly includes a plurality of electrode stack layers, and each electrode stack layer of the plurality of electrode stack layers includes a major side surface that is positioned normal to the first major face and the second major face of the prismatic outer housing.

In a further non-limiting embodiment of the foregoing prismatic battery cell, the plurality of electrode stack layers are stacked vertically on top of one another such that each of the major side surfaces extends in parallel with a minor face located at a top or a bottom of the prismatic outer housing.

In a further non-limiting embodiment of either of the foregoing prismatic battery cells, the major side surfaces of the plurality of electrode stack layers extend longitudinally in a direction of a width of the prismatic outer housing.

In a further non-limiting embodiment of any of the foregoing prismatic battery cells, a height of the prismatic outer housing is larger than the width to establish a highrise configuration of the prismatic battery cell.

In a further non-limiting embodiment of any of the foregoing prismatic battery cells, the plurality of electrode stack layers are stacked horizontally side-by-side with one another such that the major side surfaces extend in parallel with a minor face located at each opposing end of the prismatic outer housing.

In a further non-limiting embodiment of any of the foregoing prismatic battery cells, the major side surfaces of the plurality of electrode stack layers extend longitudinally in a direction of a height of the prismatic outer housing.

In a further non-limiting embodiment of any of the foregoing prismatic battery cells, the height is larger than a width of the prismatic outer housing to establish a highrise configuration of the prismatic battery cell.

In a further non-limiting embodiment of any of the foregoing prismatic battery cells, a plurality of standoffs protrude outwardly from the first major face and the second major face.

In a further non-limiting embodiment of any of the foregoing prismatic battery cells, the plurality of standoffs are fins, ribs, or dimples.

In a further non-limiting embodiment of any of the foregoing prismatic battery cells, the plurality of standoffs extend vertically or horizontally across the first major face and the second major face.

A cylindrical battery cell according to another exemplary aspect of the present disclosure includes, among other things, a cylindrical housing assembly including a cylindrical outer housing and a cover. A base of the cylindrical outer housing and the cover establish major sides surfaces of the cylindrical housing assembly. An electrode assembly is arranged inside the cylindrical outer housing. A first plurality of standoffs protrude outward from the base of the cylindrical outer housing, and a second plurality of standoffs protrude outward from the cover.

In a further non-limiting embodiment of the foregoing cylindrical battery cell, the electrode assembly includes a wound body having a major side surface that is normal to the major side surfaces of the cylindrical housing assembly.

In a further non-limiting embodiment of either of the foregoing cylindrical battery cells, the wound body includes a cinnamon-roll-like geometric configuration.

In a further non-limiting embodiment of any of the foregoing cylindrical battery cells, the first plurality of standoffs are male standoffs, and the second plurality of standoffs are female standoffs.

In a further non-limiting embodiment of any of the foregoing cylindrical battery cells, the male standoffs are configured to engage a set of female standoffs of a neighboring cylindrical battery cell.

In a further non-limiting embodiment of any of the foregoing cylindrical battery cells, a cooling channel extends between the cylindrical battery cell and the neighboring cylindrical battery cell.

In a further non-limiting embodiment of any of the foregoing cylindrical battery cells, the cooling channel establishes a tortuous path between the cylindrical battery cell and the neighboring cylindrical battery cell.

In a further non-limiting embodiment of any of the foregoing cylindrical battery cells, at least one of the first plurality of standoffs or the second plurality of standoffs are configured to collapse or crumple under an axial impact load.

In a further non-limiting embodiment of any of the foregoing cylindrical battery cells, a sidewall of the cylindrical outer housing establishes a minor side surface of the cylindrical housing assembly.

In a further non-limiting embodiment of any of the foregoing cylindrical battery cells, the cylindrical outer housing and the cover are made of aluminum.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack of an electrified vehicle.

FIG. 3 illustrates a prismatic battery cell.

FIG. 4 illustrates another exemplary prismatic battery cell.

FIG. 5 schematically illustrates a heat transfer map of the prismatic battery cell of FIG. 3.

FIG. 6 illustrates standoff features of a prismatic outer housing of a prismatic battery cell.

FIG. 7 illustrates alternative standoff features of a prismatic outer housing of a prismatic battery cell.

FIG. 8 illustrates alternative standoff features of a prismatic outer housing of a prismatic battery cell.

FIG. 9 illustrates a plurality of prismatic battery cells arranged in a cell stack.

FIG. 10 illustrates a plurality of prismatic battery cells arranged in a cell stack.

FIG. 11 is a perspective view of a cylindrical battery cell.

FIG. 12 is a side view of the cylindrical battery cell of FIG. 11.

FIG. 13 illustrates an electrode assembly of the cylindrical battery cell of FIG. 11.

FIG. 14 illustrates a heat transfer map of the cylindrical battery cell of FIG. 11.

FIGS. 15 and 16 illustrate standoff features of a cylindrical battery cell.

FIG. 17 illustrates a plurality of cylindrical battery cells arranged in a cell stack.

FIG. 18 is a cross-sectional view through section 18-18 of FIG. 17.

### DETAILED DESCRIPTION

This disclosure details battery cells for use within traction battery packs. The exemplary battery cells include designs that facilitate increased heat transfer and thermal performance. An exemplary prismatic battery cell may include an electrode assembly having a plurality of electrode stack layers, and each electrode stack layer of the plurality of electrode stack layers includes a major side surface that is positioned normal to a major face of a prismatic outer housing of the cell. An exemplary cylindrical battery cell may include a first plurality of standoffs protruding outward from a base of an cylindrical outer housing of the cell, and a second plurality of standoffs protruding outward from a cover of the cell. The standoffs cooperate to establish cooling channels when the cylindrical battery cell is stacked together with additional cylindrical battery cells. These and other features are discussed in greater detail in the following paragraphs of this detailed description.

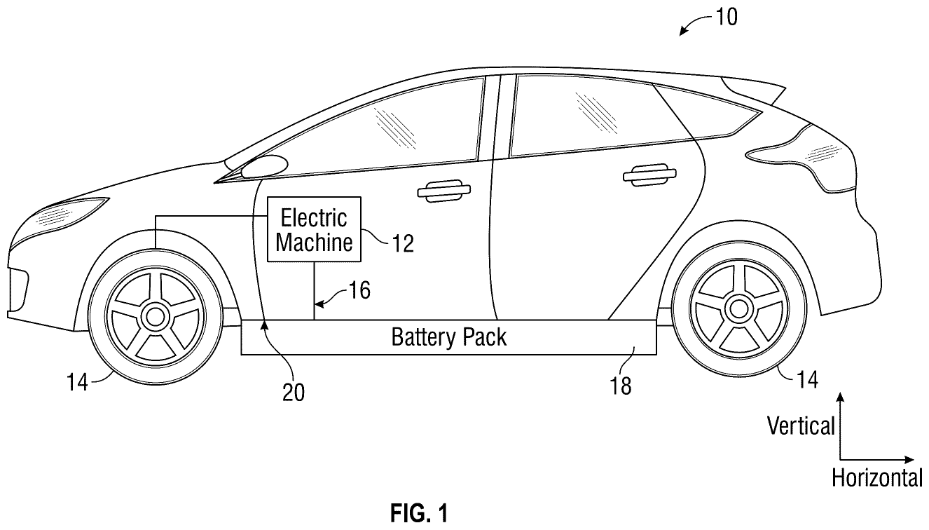

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

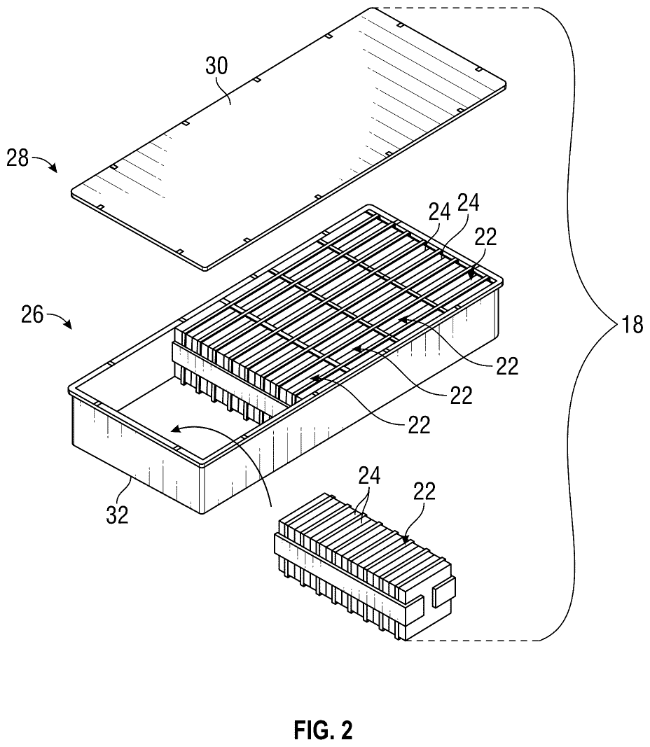

FIG. 2 schematically illustrates additional details associated with the traction battery pack 18 of the electrified vehicle 10. The traction battery pack 18 may include one or more battery arrays 22 (e.g., battery modules or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked together along a stack axis to construct a grouping of battery cells 24, sometimes referred to as a “cell stack.” The battery arrays 22 may extend in cross-car direction when the traction battery pack 18 is mounted on the electrified vehicle 10. However, other configurations may also be possible. The total numbers of battery arrays 22 and battery cells 24 provided within the traction battery pack 18 are not intended to limit this disclosure.

In an embodiment, the battery cells 24 of each battery array 22 are lithium-ion cells. However, battery cells having other chemistries (e.g., nickel-metal hydride, lead-acid, sodium ion, lithium sulfur, lithium silicon, etc.) could alternatively be utilized within the scope of this disclosure.

The battery arrays 22 and various other battery internal components (e.g., bussed electrical center, battery electric control module, wiring, connectors, etc.) may be housed within an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide an interior area 26 that houses the battery arrays 22. The size, shape, and overall configuration of the enclosure assembly 28 is not intended to limit this disclosure.

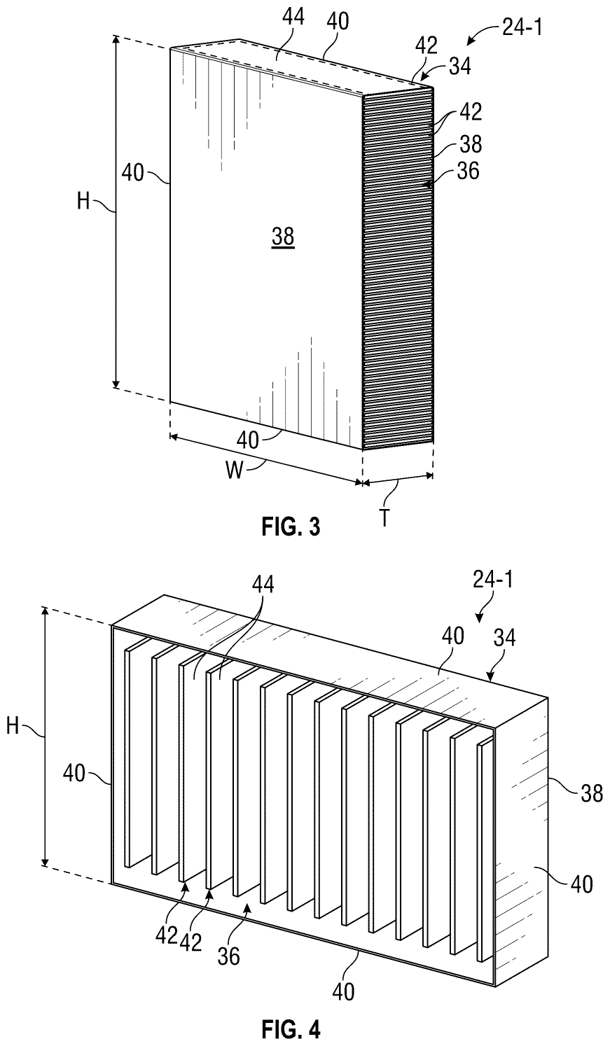

FIG. 3 illustrates a prismatic battery cell 24-1 that may be utilized within the battery arrays 22 of the traction battery pack 18 of FIGS. 1-2, for example. The prismatic battery cell 24-1 includes a prismatic outer housing 34 and an electrode assembly 36 packaged inside the prismatic outer housing 34.

The prismatic outer housing 34 may be a relatively rigid structure constructed from a metallic material, such as aluminum, for example. The prismatic outer housing 34 may be rectangular-shaped and includes a height H, a width W, and a thickness T. In an embodiment, the height H is larger than either the width W or the thickness T. The prismatic battery cell 24-1 is therefore considered to have a “highrise” configuration.

The prismatic outer housing 34 includes major faces 38 and minor faces 40. The major faces 38 exhibit a greater surface area than the minor faces 40 of the prismatic outer housing 34.

The electrode assembly 36 may include a plurality of electrode stack layers 42. Each electrode stack layer 42 includes a cathode, an anode, and one or more separators (not shown for simplicity and clarity).

The electrode stack layers 42 may be stacked together and arranged inside the prismatic outer housing 34. Each electrode stack layer 42 may be arranged such that a major side surface 44 of each electrode stack layer 42 is normal (i.e., perpendicular) to the major faces 38 of the prismatic outer housing 34.

In an embodiment, the electrode stack layers 42 are stacked vertically on top of one another such that the major side surfaces 44 of the electrode stack layers 42 extend in parallel with the minor faces 40 located at a top and a bottom of the prismatic outer housing 34 (see FIG. 3). In such an implementation, the major side surfaces 44 extend longitudinally in the direction of the width W of the prismatic outer housing 34.

In another embodiment, the electrode stack layers 42 are stacked horizontally side-by-side with one another such that the major side surfaces 44 of the electrode stack layers 42 extend in parallel with the minor faces 40 located at each opposing end of the prismatic outer housing 34 (see FIG. 4). In such an implementation, the major side surfaces 44 extend longitudinally in the direction of the height H of the prismatic outer housing 34.

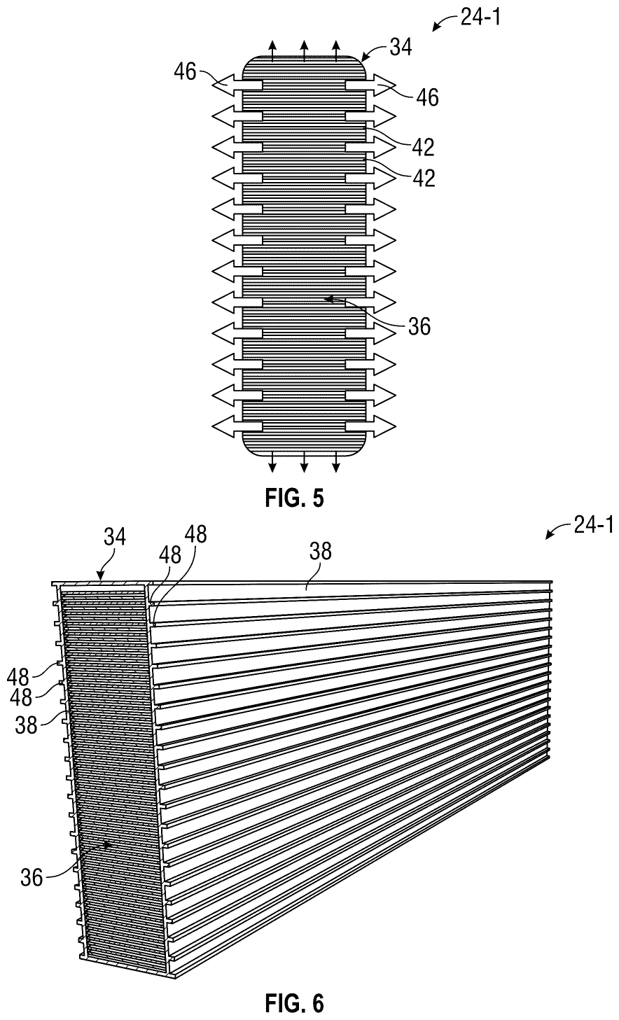

Arranging the major side surfaces 44 of the electrode stack layers 42 to be normal to the major faces 38 of the prismatic outer housing 34 optimizes the major faces 38 of the prismatic outer housing 34 and minimizes the average in-plane transfer distance from each electrode stack layer 42 to the major faces 38. The prismatic battery cell 24-1 may therefore provide increased heat transfer into/out of the major faces 38 of the prismatic outer housing 34 (as schematically illustrated by arrows 46 in FIG. 5) and thus facilitate increased cell cooling and thermal management performance.

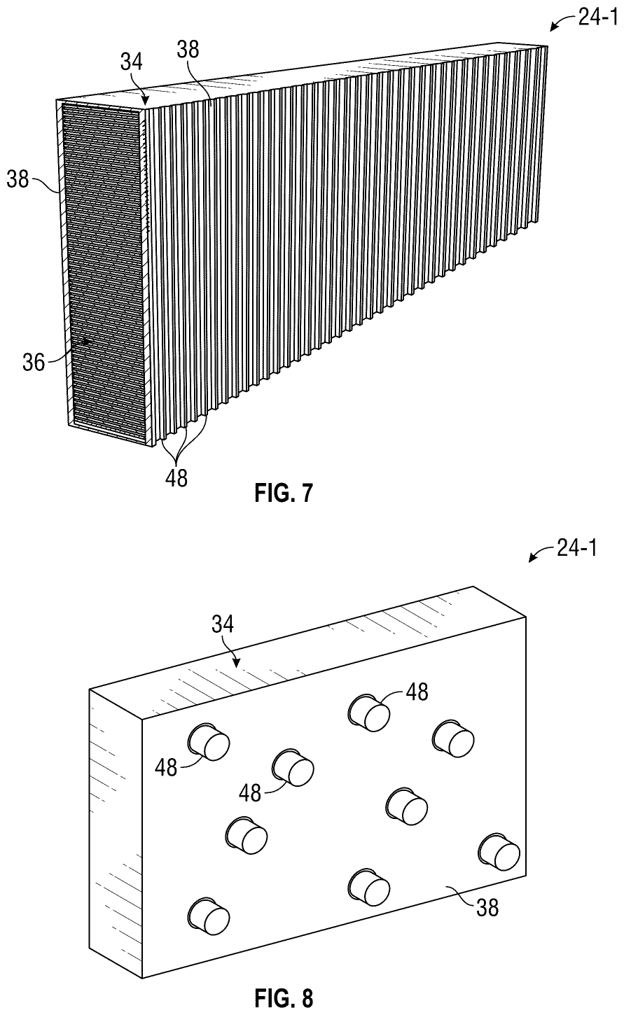

Referring now to FIGS. 6, 7, and 8, the prismatic outer housing 34 of the prismatic battery cell 24-1 may include a plurality of standoffs 48 that are configured to physically space the prismatic battery cell 24-1 from adjacent battery cells within a battery array. The standoffs 48 may be provided on the major faces 38 of the prismatic outer housing 34 and may be arranged to extend horizontally (see FIG. 6) or vertically (see FIG. 7). The standoffs 48 may be configured as fins or ribs (see FIGS. 6 and 7) or as dimples (see FIG. 8).

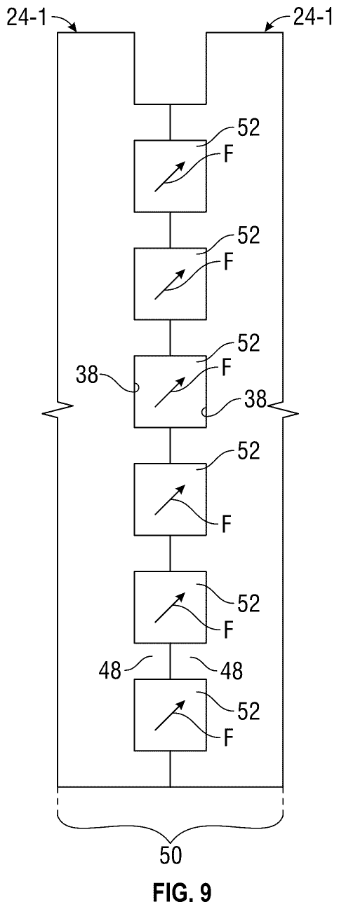

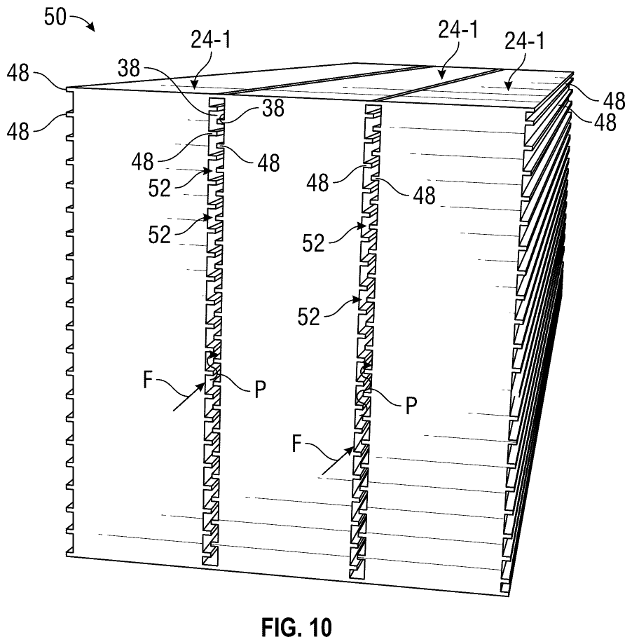

Referring now to FIGS. 9 and 10, the prismatic battery cell 24-1 may be stacked together with other prismatic battery cells 24-1 to construct a cell stack 50. The standoffs 48 physically separate the prismatic battery cells 24-1 from one another and establish cooling channels 52 that extend therebetween. A cooling fluid F (e.g., air) may be communicated through the cooling channels 52 and thus may directly contact the major faces 38 of the prismatic battery cells 24-1, thereby optimizing thermal management performance.

In an embodiment, the standoffs 48 of adjacent prismatic battery cells 24-1 align with and abut one another to establish the cooling channels 52 (see FIG. 9). In another embodiment, the standoffs 48 of adjacent prismatic battery cells 24-1 are staggered to establish the cooling channels 52 and allow the cooling fluid F to travel along a tortuous path P between the cells (see FIG. 10).

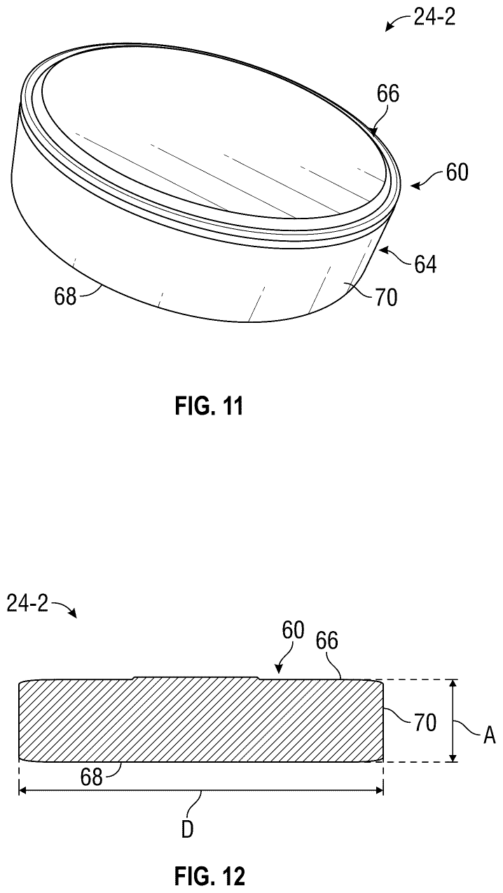

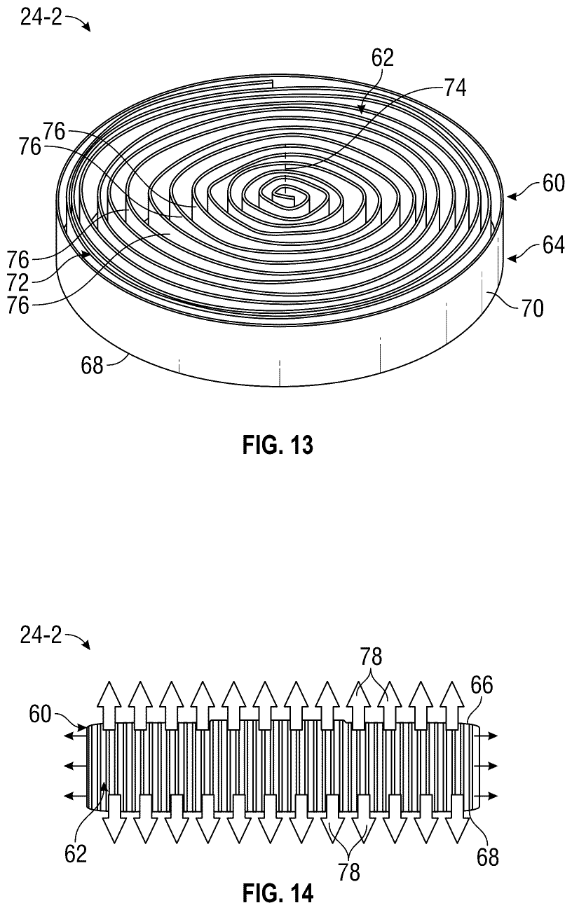

FIGS. 11-14 illustrate a cylindrical battery cell 24-2 that may be utilized within the battery arrays 22 of the traction battery pack 18 of FIGS. 1-2, for example. The cylindrical battery cell 24-2 includes a cylindrical housing assembly 60 and an electrode assembly 62 (see FIG. 13) arranged inside the cylindrical housing assembly 60.

The cylindrical housing assembly 60 may include an cylindrical outer housing 64 and a cover 66. The cover 66 may be secured to the cylindrical outer housing 64 to contain the electrode assembly 62 therein. The cylindrical outer housing 64 and the cover 66 may be relatively rigid structures constructed from a metallic material, such as aluminum, for example. The cover 66 is removed in FIG. 13 for better illustrating the electrode assembly 62.

The cylindrical housing assembly 60 includes a diametral dimension D and an axial dimension A (see FIG. 12). In an embodiment, the diametral dimension D is larger than the axil dimension A. In another embodiment, the diametral dimension D is about two times, about three times, or about four times larger than the axil dimension A. However, the aspect ratio established by the diametral dimension D is larger than the axil dimension A may provide other ratios. The cylindrical battery cell 24-2 is considered to have a button-like configuration.

Due to the aspect ratio established by making the diametral dimension D larger than the axial dimension A, the cover 66 and a base 68 of the cylindrical outer housing 64 establish major side surfaces of the cylindrical housing assembly 60, and a side wall 70 of the cylindrical outer housing 64 establishes a minor side surface of the cylindrical housing assembly 60. The major side surfaces exhibit a greater surface area than the minor side surface of the cylindrical housing assembly 60.

The electrode assembly 62 may sometimes be referred to as a “jelly-roll” or active material and includes a cathode, an anode, and one or more separators (not shown for simplicity and clarity). The electrode assembly 62 may include a wound body 72 that is wrapped around a wrap axis 74. The wound body 72 may be arranged within the cylindrical outer housing 64 such that a major side surface 76 of the electrode assembly 62 is normal (i.e., perpendicular) to the major side surfaces provided by the cover 66 and the base 68. The electrode assembly 62 is therefore considered to have a cinnamon roll geometric configuration.

Arranging the major side surface 76 of the electrode assembly 62 to be normal to the major side surfaces of the cylindrical housing assembly 60 optimizes the major faces of the cylindrical battery cell 24-2 and minimizes the average in-plane transfer distance from the electrode assembly 62 to the major side surfaces provided by the cover 66 and the base 68. The cylindrical battery cell 24-2 may therefore provide increased heat transfer into/out of the major side surfaces of the cylindrical battery cell 24-2 (as schematically illustrated by arrows 78 in FIG. 14) and thus facilitates increased cell cooling and thermal management performance.

The cylindrical battery cell 24-2 may additionally employ a “tab-less’ design in which the electrode assembly 62 is electrically connected to the cover 66 and/or the base 68 without the use of current collector tabs. Such a design configures the cell for more readily being cooled on the large axial end surfaces of the cylindrical housing assembly 60.

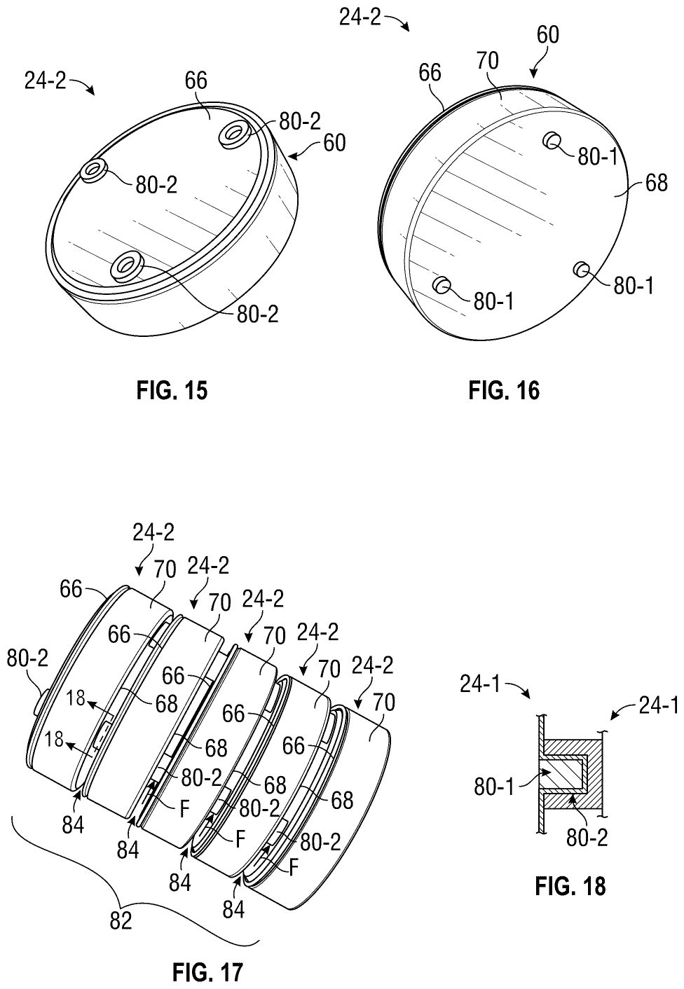

Referring now to FIGS. 15, 16, 17, and 18, the cylindrical housing assembly 60 of the cylindrical battery cell 24-2 may include may include a plurality of standoffs that are configured to physically space the cylindrical battery cell 24-2 from adjacent battery cells within a battery array. A first plurality of standoffs 80-1 may protrude outwardly from the base 68 of the cylindrical outer housing 64, and a second plurality of standoffs 80-2 may protrude outwardly from the cover 66.

The cylindrical battery cell 24-2 may be stacked together with other cylindrical battery cells 24-2 to construct a cell stack 82 (see FIG. 17). The standoffs 80-1, 80-2 physically separate the cylindrical battery cells 24-2 from one another and establish cooling channels 84 that extend therebetween. A cooling fluid F (e.g., air) may be communicated through the cooling channels 84 and thus may directly contact the major side surfaces (e.g., the cover 66 and the base 68) of the cylindrical battery cells 24-2, thereby optimizing thermal management performance.

The first plurality of standoffs 80-1 may be configured as male standoffs, and the second plurality of standoffs 80-2 may be configured as female standoffs. The first plurality of standoffs 80-1 of one cylindrical battery cell 24-2 of the cell stack 82 may engage (e.g., interlock with, see FIG. 18) the second plurality of standoffs 80-2 of a neighboring cylindrical battery cell 24-2 of the cell stack 82 to space the cell from one another and establish the cooling channels 84. The cooling fluid F may travel over and around the engaged standoffs 80-1, 80-2 along a tortuous path P between the cells for providing an increased cooling effect.

In an embodiment, the first plurality of standoffs 80-1 and/or the second plurality of standoffs 80-2 may be engineered to collapse, crumple or otherwise fail under axial impact loads that are directed across a stack axis of the cell stack 82. The standoffs 80-1, 80-2 may therefore absorb impact energy that could otherwise be directed into the cylindrical housing assemblies 60 of the cylindrical battery cells 24-2.

The battery cell design variations described herein enable increased heat transfer capability and lower the temperature gradient range and peak temperature within the cells. The proposed designs therefore prolong the life cycle of the battery cell compared to conventional battery cell designs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A prismatic battery cell, comprising:
a prismatic outer housing including a first major face and a second major face; and
an electrode assembly arranged inside the prismatic outer housing,
wherein the electrode assembly includes a plurality of electrode stack layers, and each electrode stack layer of the plurality of electrode stack layers includes a major side surface that is positioned normal to the first major face and the second major face.

2. The prismatic battery cell as recited in claim 1, wherein the plurality of electrode stack layers are stacked vertically on top of one another such that each of the major side surfaces extends in parallel with a minor face located at a top or a bottom of the prismatic outer housing.

3. The prismatic battery cell as recited in claim 2, wherein the major side surfaces of the plurality of electrode stack layers extend longitudinally in a direction of a width of the prismatic outer housing.

4. The prismatic battery cell as recited in claim 3, wherein a height of the prismatic outer housing is larger than the width to establish a highrise configuration of the prismatic battery cell.

5. The prismatic battery cell as recited in claim 1, wherein the plurality of electrode stack layers are stacked horizontally side-by-side with one another such that the major side surfaces extend in parallel with a minor face located at each opposing end of the prismatic outer housing.

6. The prismatic battery cell as recited in claim 5, wherein the major side surfaces of the plurality of electrode stack layers extend longitudinally in a direction of a height of the prismatic outer housing.

7. The prismatic battery cell as recited in claim 6, wherein the height is larger than a width of the prismatic outer housing to establish a highrise configuration of the prismatic battery cell.

8. The prismatic battery cell as recited in claim 1, comprising a plurality of standoffs that protrude outwardly from the first major face and the second major face.

9. The prismatic battery cell as recited in claim 8, wherein the plurality of standoffs are fins, ribs, or dimples.

10. The prismatic battery cell as recited in claim 8, wherein the plurality of standoffs extend vertically or horizontally across the first major face and the second major face.

11. A cylindrical battery cell, comprising:
a cylindrical housing assembly including a cylindrical outer housing and a cover,
wherein a base of the cylindrical outer housing and the cover establish major sides surfaces of the cylindrical housing assembly;
an electrode assembly arranged inside the cylindrical outer housing;
a first plurality of standoffs protruding outward from the base of the cylindrical outer housing; and
a second plurality of standoffs protruding outward from the cover.

12. The cylindrical battery cell as recited in claim 11, wherein the electrode assembly includes a wound body having a major side surface that is normal to the major side surfaces of the cylindrical housing assembly.

13. The cylindrical battery cell as recited in claim 12, wherein the wound body includes a cinnamon-roll-like geometric configuration.

14. The cylindrical battery cell as recited in claim 11, wherein the first plurality of standoffs are male standoffs, and the second plurality of standoffs are female standoffs.

15. The cylindrical battery cell as recited in claim 14, wherein the male standoffs are configured to engage a set of female standoffs of a neighboring cylindrical battery cell.

16. The cylindrical battery cell as recited in claim 15, comprising a cooling channel extending between the cylindrical battery cell and the neighboring cylindrical battery cell.

17. The cylindrical battery cell as recited in claim 16, wherein the cooling channel establishes a tortuous path between the cylindrical battery cell and the neighboring cylindrical battery cell.

18. The cylindrical battery cell as recited in claim 11, wherein at least one of the first plurality of standoffs or the second plurality of standoffs are configured to collapse or crumple under an axial impact load.

19. The cylindrical battery cell as recited in claim 11, wherein a sidewall of the cylindrical outer housing establishes a minor side surface of the cylindrical housing assembly.

20. The cylindrical battery cell as recited in claim 11, wherein the cylindrical outer housing and the cover are comprised of aluminum.
